(19) United States
(12) Patent Application Publication
(10) Pub. No.: US 2009/0231960 A1
(43) Pub. Date: Sep. 17, 2009

(54) GSM mobile watch phone

(76) Inventor: Gavin James Hutcheson, Sanctuary Cove (AU)

Correspondence Address: ABELMAN, FRAYNE & SCHWAB, 666 THIRD AVENUE, 10TH FLOOR, NEW YORK, NY, 10017, US

(21) Appl. No.: 12/380,567

(22) Filed: Feb. 27, 2009

Related U.S. Application Data
(63) Continuation-in-part of application No. PCT/AU2007/001211, filed on Aug. 23, 2007.

(30) Foreign Application Priority Data
Aug. 27, 2006 (AU) AU 2006203711
Jun. 22, 2007 (AU) AU 2007904058

(51) Int. Cl. G04B 47/00; H04M 1/05; H04B 1/38

(52) U.S. Cl. 368/10; 455/575.6; 379/430

(57) ABSTRACT

The present invention relates generally to a wrist watch phone adapted to be worn by a person. The watch (10) comprises a communication module (20) adapted to operate under Global System of Mobile (GSM) telephone networks, to work with quad frequency bands, and to send audio data across said GSM telephone networks. It also has a display adapted to display time, and to provide a graphic interface for showing a status of said communication module. The watch shell encloses the display, and the communication module. The watch has strips for fastening around the wrist of the person.

### CROSS REFERENCE TO RELATED APPLICATIONS

The present application is a continuation-in-part of International Patent Application PCT/AU2007/001211, entitled “GSM Mobile Watch Phone”, designating USA and filed on Aug. 23, 2007, and which claims priority of Australian Patent Application AU 2006203711, filed on Aug. 27, 2006, and Australian Patent Application AU 2007904058, filed on Jun. 22, 2007. The content of each of these applications is incorporated herein by reference and made a part of this application.

### TECHNICAL FIELD

The present invention relates to a wrist watch kind mobile phone and in particular a wrist watch phone design for use in GSM telephone network that may operate over several frequency bands.

### BACKGROUND ART

Wrist watches are commonly known to provide the basic function of time keeping. Modern wrist watches have a number of extra functions that make them more than just a time piece.

It has long been desired to make a wrist watch that provides a two-way communication function, but it is difficult to build one in practice.

One of the challenges involved in producing such a wrist watch is the difficulty of reducing the size of the electronic components to fit them within a housing that is wearable by a person on the wrist. Typically the dimension of a wearable wrist watch is 50×60×15 mm which is much smaller than that of a typical mobile phone which is around 100×60×15 mm, or larger.

It is known to provide a wrist mounted mobile telephone watch, such as that shown in U.S. Pat. No. 6,567,523 which describes a wrist mounted telephone device having a watch unit and telephone unit. However, this device has the telephone unit separate from the time unit, where each of the units has its own housing. As a result, there are many different parts in the watch and it is not convenient to use, or to wear.

It would also be desirable to provide a wrist watch phone that ameliorates or overcomes one or more of the disadvantages of such devices or that may provide a useful alternative to these devices.

### DISCLOSURE OF THE INVENTION

According to the invention there is provided wrist watch phone wearable by a person comprising

a communication module adapted to operate under Global System of Mobile (GSM) telephone networks, to operate with a plurality of GSM frequency bands, and to send audio data across said GSM telephone networks;

an internal antenna being substantially in a sheet form and connecting to said communication module, wherein said internal antenna is adapted to transmit signals to and receive signals from said GSM telephone networks;

a display adapted to at least display time, and to provide a graphic interface for showing a status of said communication module;

a power supply connecting to said communication module, wherein said power supply is adapted to provide power to said wrist watch mobile phone; and

a housing means adapted to enclose said display, said internal antenna, said communication module and said power supply;

wherein the housing means comprises any one or more of titanium, and non-metal.

In a preferred embodiment, said non-metal comprises any one or more of stainless steel, plastics polycarbonate plastic, resin, glass and ceramic.

Preferably, the wrist watch phone of claim 1 comprising a retaining means adapted to secure said retaining means around a wrist.

In a preferred embodiment, said communication module adapted to operate with at least three GSM frequency bands.

In a preferred embodiment, said communication module adapted to operate in quad bands mode.

In a preferred embodiment, said GSM frequency bands include any one or more of 800 Mhz, 850 MHz, 900 MHz, 1800 MHz, 1900 MHz, 2000 MHz, 2100 Mhz, 2500 MHz, 2600 MHz, 2700 MHz, 2800 MHz, 2900 MHz, 3000 MHz, 3500 MHz, 4000 MHz, 4500 MHz, and 5000 MHz.

Preferably, said communication module adapted to operate under Voice Over IP (VoIP), Wi-Fi, InfraRed, Worldwide interoperability Microwave Access (WiMAX).

In a preferred embodiment, said internal antenna comprises of plastic and copper to produce a maximum spurious emission limit of −13 DBM.

In a preferred embodiment, said power supply includes a non-rechargeable or solar power battery or panel.

In a preferred embodiment, said power supply includes a rechargeable battery adapted to provide power to said communication module and said display module.

In a preferred embodiment, said rechargeable system comprises a USB connector.

In a preferred embodiment, said rechargeable system is power supplied by limited power source and mounted on PCB of flammability class V-0 or above.

In a preferred embodiment, said rechargeable system operates with a rate input range between 110 to 240V, 50 to 60 Hz, a rate output range between 0.000001 mA to 4500 mA, and an operation temperature between 1 to 78° C.

In a preferred embodiment, said display is any one of organic light emitting system applied onto an organic substrate.

In a preferred embodiment, said display is any one of Thin Film Transistor Liquid Crystal Display (TFTLCD) or Liquid Crystal Display (LCD).

In a preferred embodiment, said display is comprises a system using amorphous or polycrystalline silicon, or indium tin oxide.

In a preferred embodiment, said display is made of any one of plastic or glass.

In a preferred embodiment, said display is a touch screen.

In a preferred embodiment, said display is adapted to display 256 colours.

In a preferred embodiment, said communication module is adapted to communicate via IP Packets Exchange network.

In a preferred embodiment, said wrist watch is adapted to operate with a Subscriber Identity Module (SIM) card.

In a preferred embodiment, said wrist watch includes a Global Positioning System (GPS) module connecting to said communication module, wherein said GPS module determines at least one coordinate data of said wrist watch phone and displays said coordinate data on said display.

In a preferred embodiment, said communication module has a baseband module adapted to process, send and receive digital data.

In a preferred embodiment, said digital data include emails, telephone calls, text messages, multimedia messages, files, videos, sounds, voices, music, pictures and games.

In a preferred embodiment, said wrist watch is adapted to send an email when said GPS has detected that said wrist watch phone is outside a predetermined geographical area.

In a preferred embodiment, said wrist watch has a Bluetooth communication module to connect to a Bluetooth compatible device.

In a preferred embodiment, said retaining means includes a security encryption device for securely locking said wrist watch around a wrist.

In a preferred embodiment, said security encryption device is adapted to receive wireless signals for locking and unlocking said security encryption device.

In a preferred embodiment, said communication module includes a customized Printed Circuit Board (PCB).

In a preferred embodiment, said PCB includes

a Radio Frequency (RF) module adapted to send and receive digital signals through GSM telephone networks using one of said three multiply frequency bands, and

a baseband module adapted to convert data from at least one input to said digital signals and to convert said digital signals from said RF module, to data for output devices.

In a preferred embodiment, said baseband module is adapted to send and receive data from at least one of the devices including: a USB device, an I/O device, a keypad, a Bluetooth device, a Real Time Clock (RTC), a Time Stamp Counter (TSC), a Microphone, a headset, a system clock, a display and a camera.

In a preferred embodiment, said baseband module is adapted to collect status information from said rechargeable battery module and display said status information on said display.

In a preferred embodiment, there is provided a software module for use in the wrist watch phone of any one of the preceding paragraphs, said software comprising:

a protocol stack adapted to provide application programming interface (API) for said communication module; and

a man to machine interface adapted to accept input from a user and pass said input to said communication module using said API, and to display output from said communication module using said API.

In a preferred embodiment, said API in a format compatible with at least one high level computer languages.

In a preferred embodiment, said API in a format compatible with wireless application protocol.

In a preferred embodiment, said protocol stack has a battery control module for minimizing battery usage by optimizing the use of graphics

In a preferred embodiment, said protocol stack is adapted to handle IP Exchange packets.

### BRIEF DESCRIPTION OF DRAWINGS

The invention is now discussed with reference to drawings, where:

FIG. 1 is a front view of GSM watch phone according to one embodiment of the present invention;

FIG. 2 is a view showing the internal components of the watch phone of FIG. 1;

FIG. 3 is a back view of FIG. 2;

FIG. 4 is an expanded view of the circuit board shown in FIG. 3;

FIG. 5 is a view of the reverse side of the circuit board of FIG. 4;

FIG. 6 is a block diagram of the RF module of watch phone of FIG. 1;

FIG. 7 is a block diagram of the baseband module of watch phone of FIG. 1;

FIG. 8 is a schematic diagram of the software architecture of watch phone of FIG. 1;

FIG. 9 is a schematic diagram of the circuit board of FIG. 4;

FIG. 10 is a schematic diagram of the circuit board of FIG. 5;

FIG. 11 is the first layer of circuit board of FIG. 4;

FIG. 12 is the second layer of circuit board of FIG. 4;

FIG. 13 is the third layer of circuit board of FIG. 4;

FIG. 14 is the forth layer of circuit board of FIG. 4;

FIG. 15 is the fifth layer of circuit board of FIG. 4;

FIG. 16 is the sixth layer of circuit board of FIG. 4;

FIG. 17 is the seventh layer of circuit board of FIG. 4;

FIG. 18 is the eighth layer of circuit board of FIG. 4;

FIG. 19 is the ninth layer of circuit board of FIG. 4; and

FIG. 20 is the tenth layer of circuit board of FIG. 4.

### BEST MODES FOR CARRYING OUT THE INVENTION

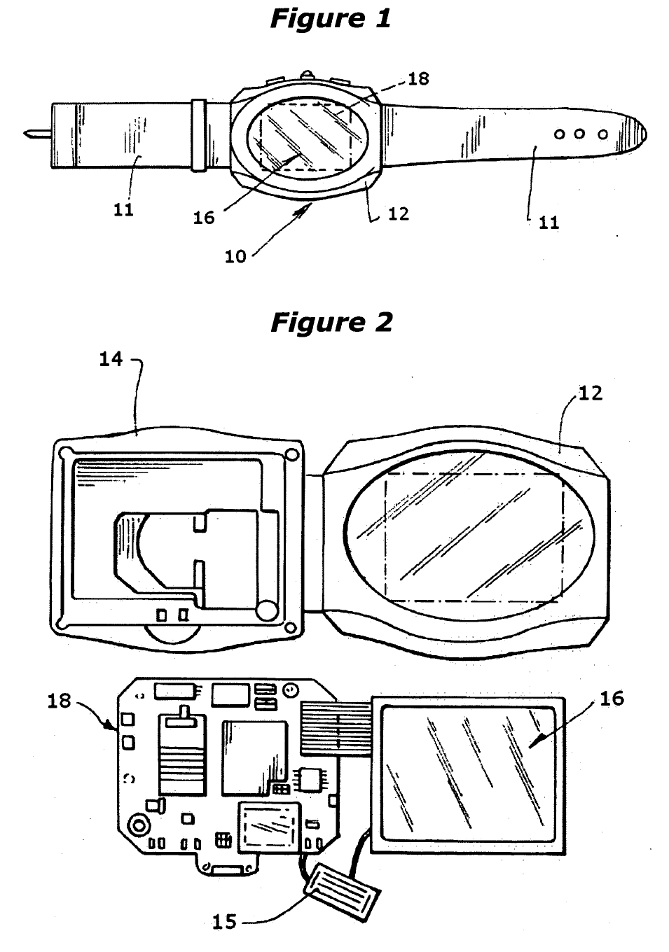

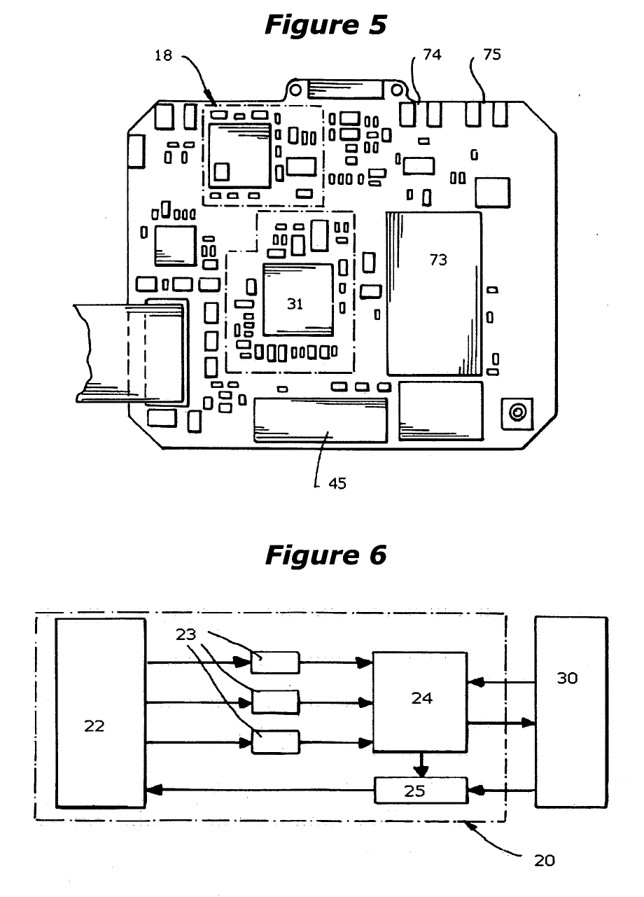

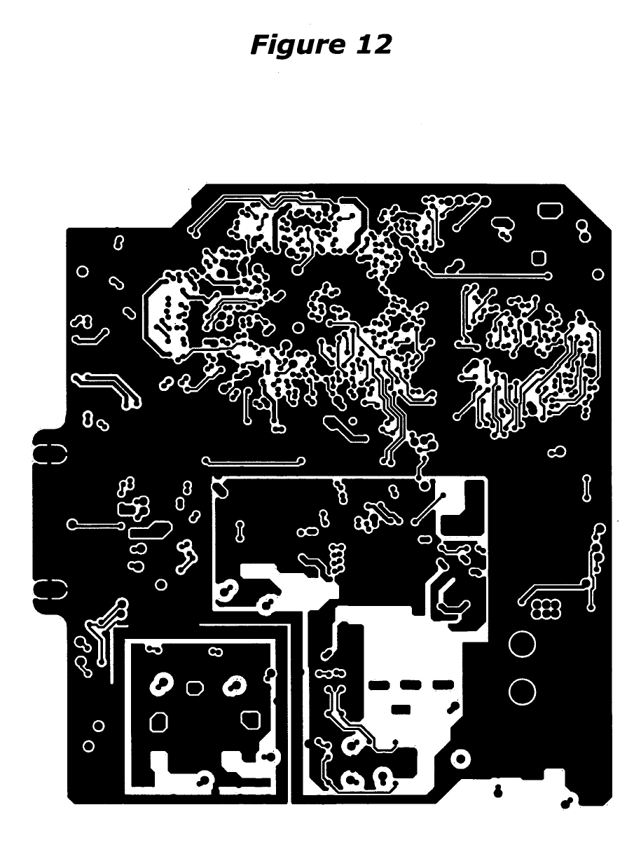

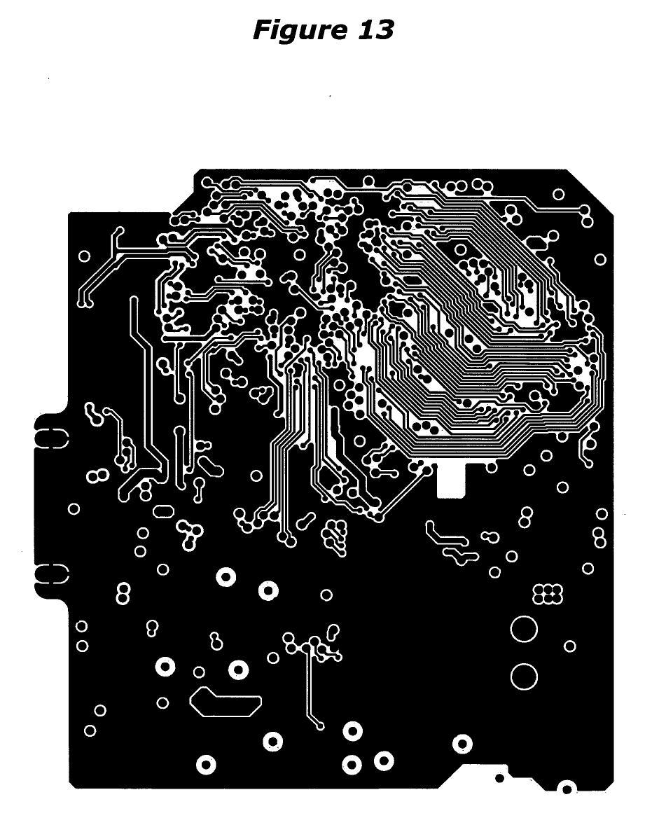

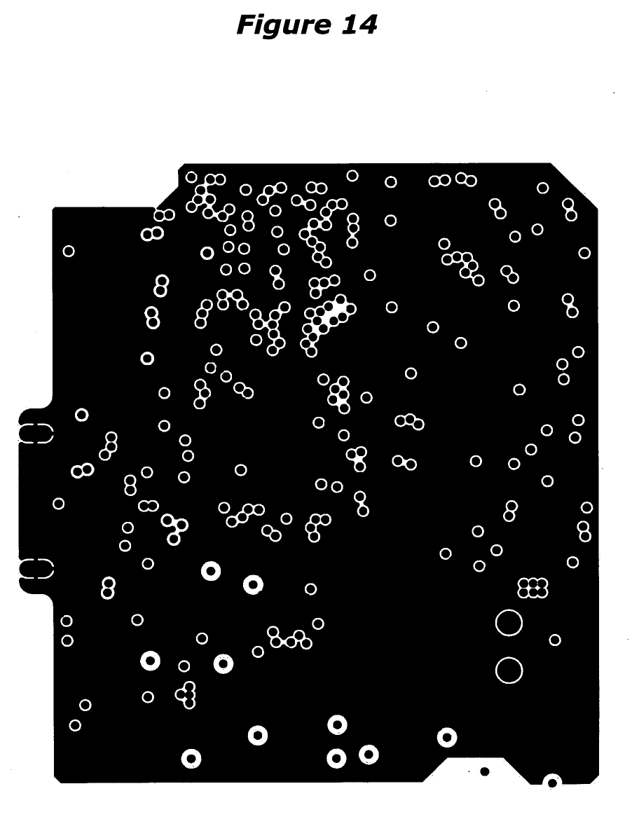

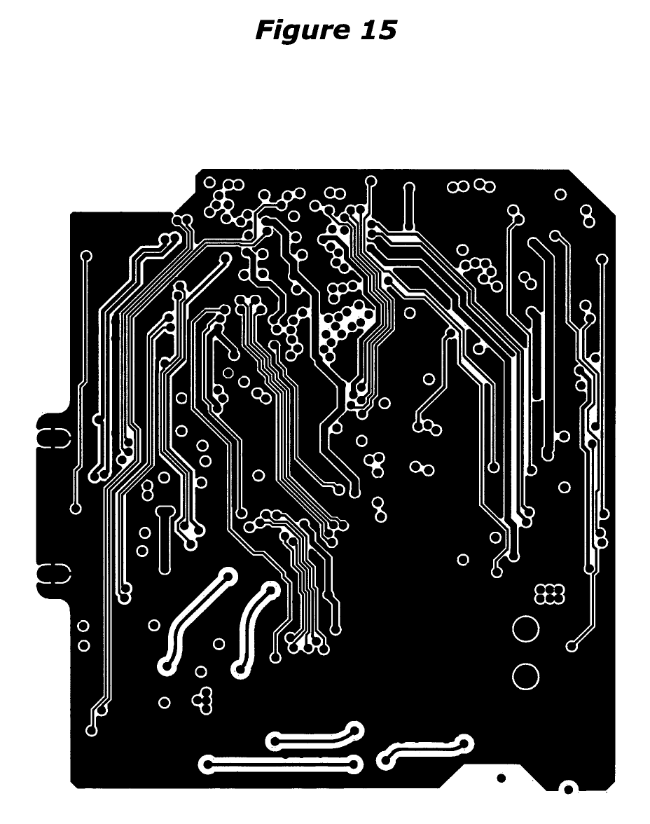

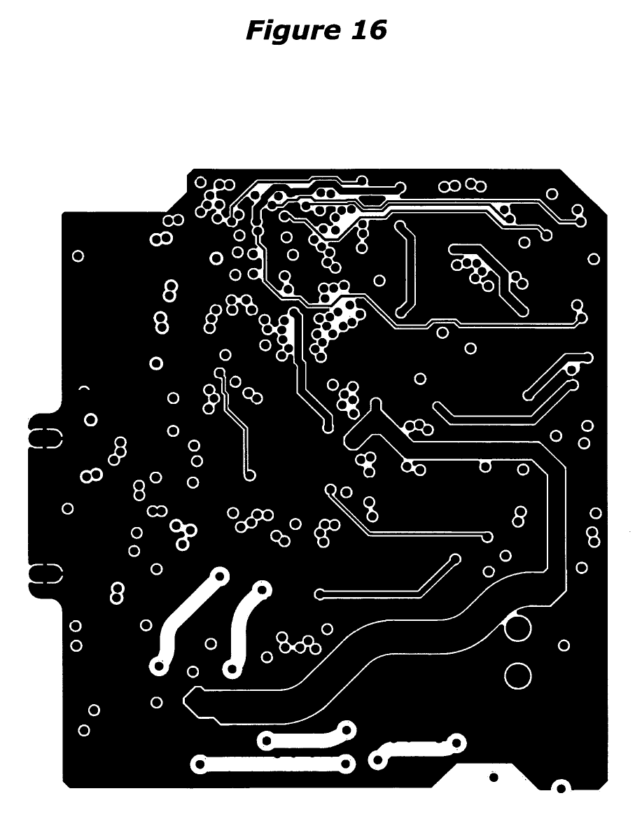

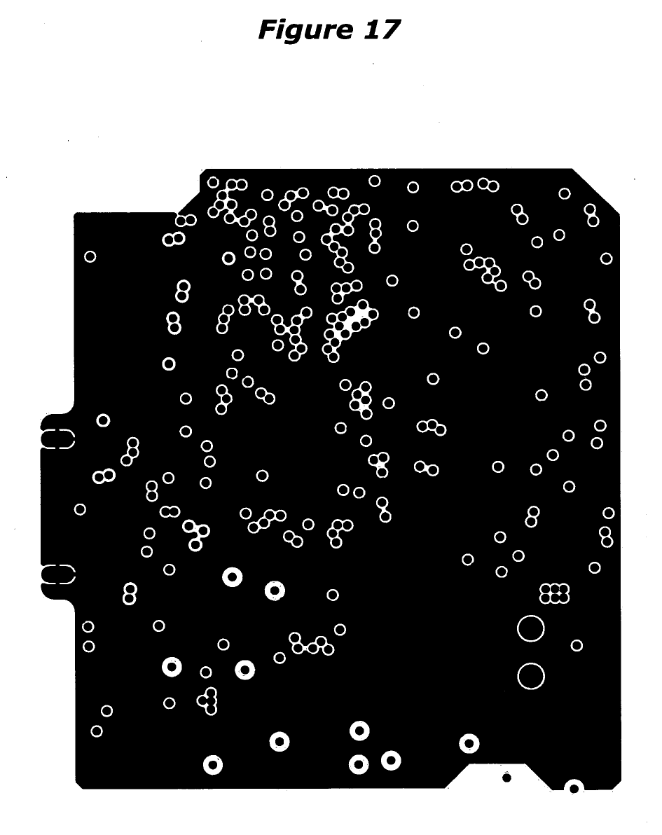

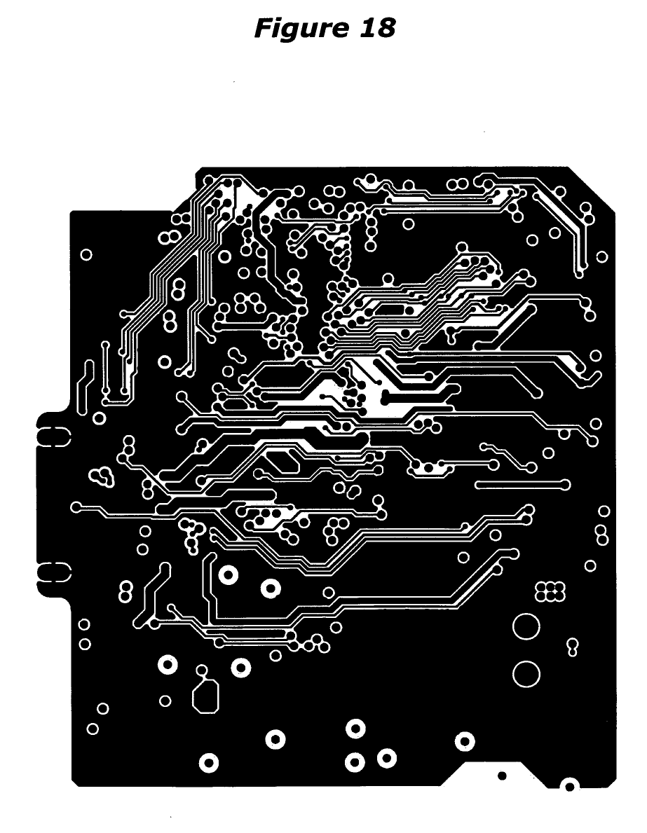

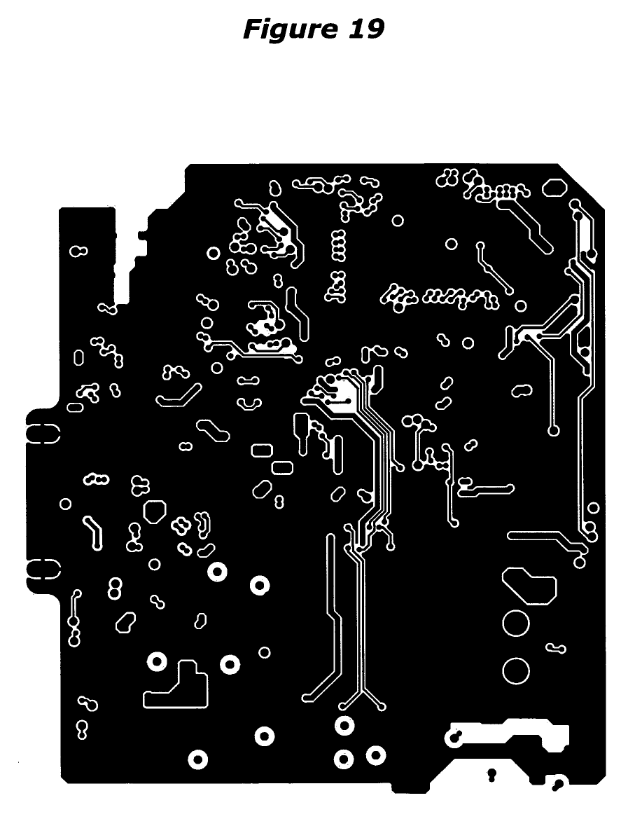

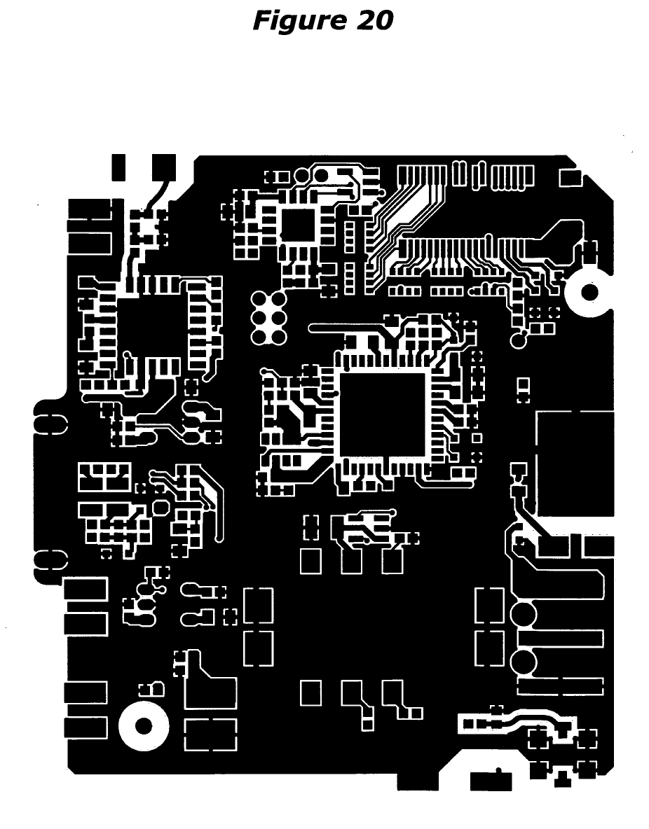

Referring to FIGS. 1 to 20, the invention provides a wrist watch phone (9) wearable by a person. Preferably, the wrist watch has a size of about 50×60×15 mm which is smaller than that of a typical mobile phone.

Referring to FIGS. 1 to 2 the wrist watch phone has a housing (10) that includes a display (16) that is connected to a communication module (18). The front shell (12) of the housing (10) and the back shell (14) of the housing enclose the display (16) and the communication module (18). The wrist watch phone has straps (11) or some other suitable form of watch band for fastening around a wrist of a person. Preferably, the watch phone includes some sort of watch band, but it may be provided or sold without one, so that the users can add their own watch band later.

The communication module (18) is able to operate under the Global System for Mobile communications (GSM) telephone networks. The GSM telephone network is commonly used for mobile telephone communication and normally operates over one or more of four frequency ranges, such as the frequency bands of 850 MHz, 900 MHz, 1800 MHz and 1900 MHz, depending on the system adopted by a particular country. Different countries may have different operation bands.

Traditionally, mobile phones only support one frequency band for communication. However, some countries use two frequency bands to provide a better coverage of the mobile networks, and therefore some mobile phones are designed to support two bands. This type of mobile phones is known as a “dual band” mobile phone. Mobile phones that support three bands are known as “tri band” mobile phones and mobile phones that support four bands are known as “quad band” mobile phones.

The communication module (18) has a customized Printed Circuit Board (PCB) (19) to accommodate all the electronics for supporting four or more different GSM frequency bands communication as well as a number of 3G frequency bands including 806 to 890 MHz, 1710 to 1885 MHz and 1901 to 2200 MHz. Below is a table showing an example of the operational GSM frequency bands of a watch phone.

TABLE 1
Operational GSM frequency bands of GSM Watch Phone

| System | Band | Uplink | Downlink | Channel Number |
|---|---|---|---|---|
| GSM 400 | 450 | 450.4-457.6 | 460.4-467.6 | 259-293 |
| GSM 400 | 480 | 478.8-486.0 | 488.8-496.0 | 306-340 |
| GSM 850 | 850 | 824.0-849.0 | 869.0-894.0 | 128-251 |
| GSM 900 | 900 | 890.0-915.0 | 935.0-960.0 | 1-124 |
| (P-GSM) | | | | |
| GSM 900 | 900 | 880.0-915.0 | 925.0-960.0 | 975-1023, |
| (E-GSM) | | | | (0, 1-124) |
| GSM-R (R- | 900 | 876.0-915.0 | 921.0-960.0 | 955-973, |
| GSM) | | | | (0, 1-124, |
| | | | | 975-1023) |
| DCS 1800 | 1800 | 1710.0-1785.0 | 1805.0-1880.0 | 512-885 |
| PCS 1900 | 1900 | 1850.0-1910.0 | 1930.0-1990.0 | 512-810 |

In addition to those GSM frequency bands, the PCB of the watch phone may also accommodate all the electronics for supporting a number of different communication systems including Voice Over IP (VoIP), Wi-Fi, InfraRed, Worldwide interoperability Microwave Access (WiMAX) for sending audio data. The PCB contains multiply layers of circuits and in a preferred embodiment, may have ten different layers of circuit etched on the PCB. As a result, it is possible to share the components between the different standards for supporting all different bands.

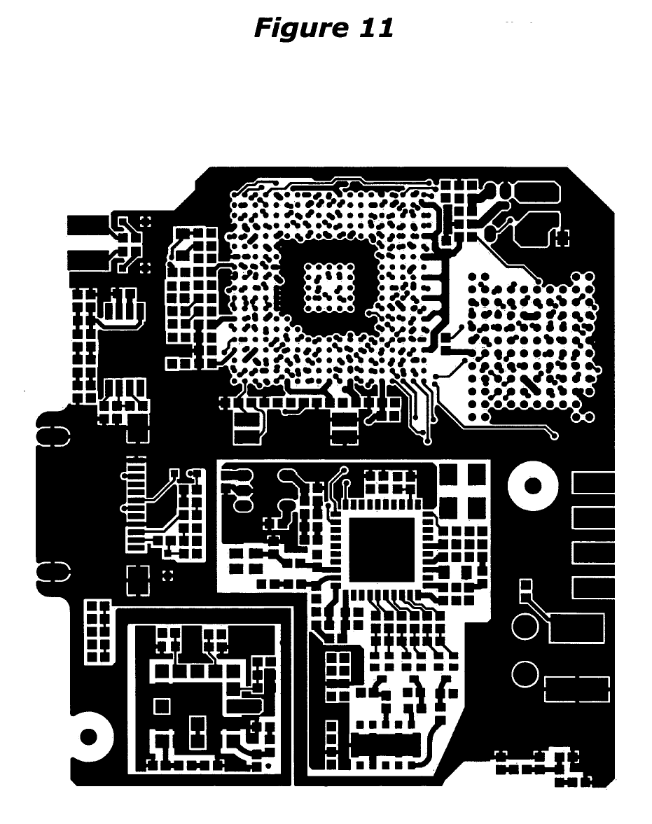

FIGS. 11 to 20 show the circuit layouts of all the layers of the circuit board. The electronic components of the watch phone utilises all these ten layers of circuit board such that the communication module (18) may work across all the different frequency bands.

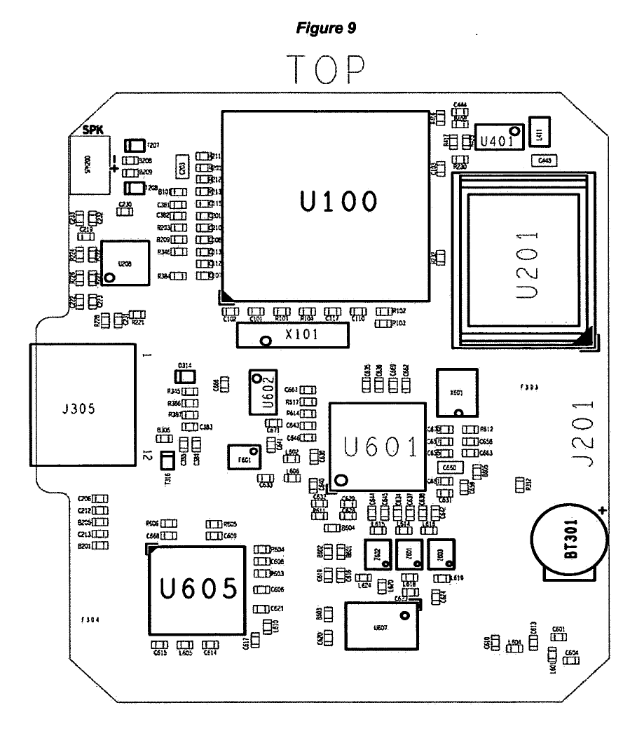

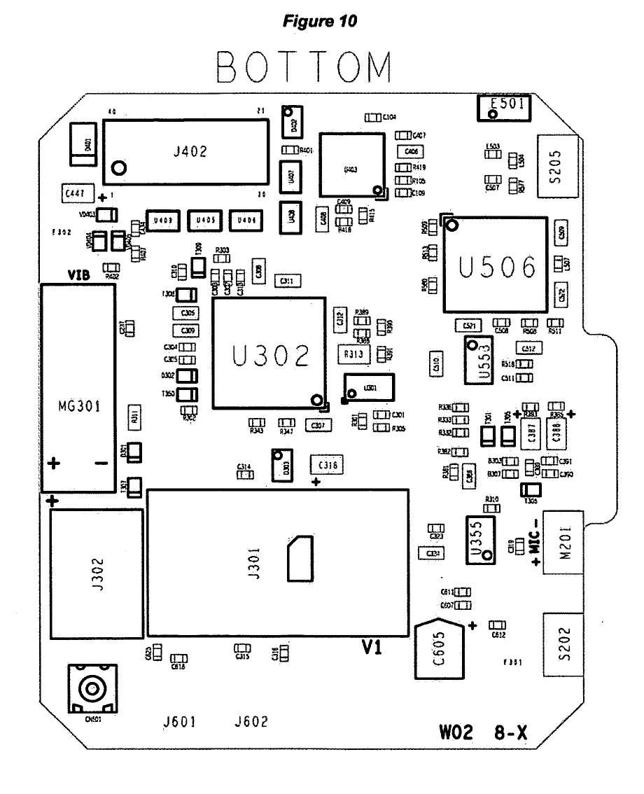

Referring to FIGS. 9 and 10, which are schematic diagrams of the communication module (18), the PCB includes a Radio Frequency (RF) module and a baseband module (30). As shown in FIG. 6, the RF module consists of a transmitter/receiver (T/R) assembly (22), RF Surface acoustic wave (SAW) filters (23), a transceiver (24), an amplifier (25).

In receiving mode, the T/R assembly has an antenna and a T/R switch for receiving signals from the GSM network. The signals are then passed to the SAW filter (23), and the transceiver (24) for down-converting. The transceiver converts the signals to data for further processing in the baseband module (30).

In transmitting mode, the data is passed to the transceiver (24) to generate the necessary R/F signals. The R/F signals are then passed to the amplifier (25) which magnifies the signals to the power level within the burst ramping mask. The magnified signals are then transmitted to the GSM network through the antenna.

The baseband module (30) controls all the functions of the watch except for the transmitting and receiving signals, which is controlled by the RF module. It accepts the data down-converted from the transceiver and further processes it and distributes it to the designated devices of the watch. It is also responsible for receiving input from those devices, processing them and pushing the data to the RF module for sending.

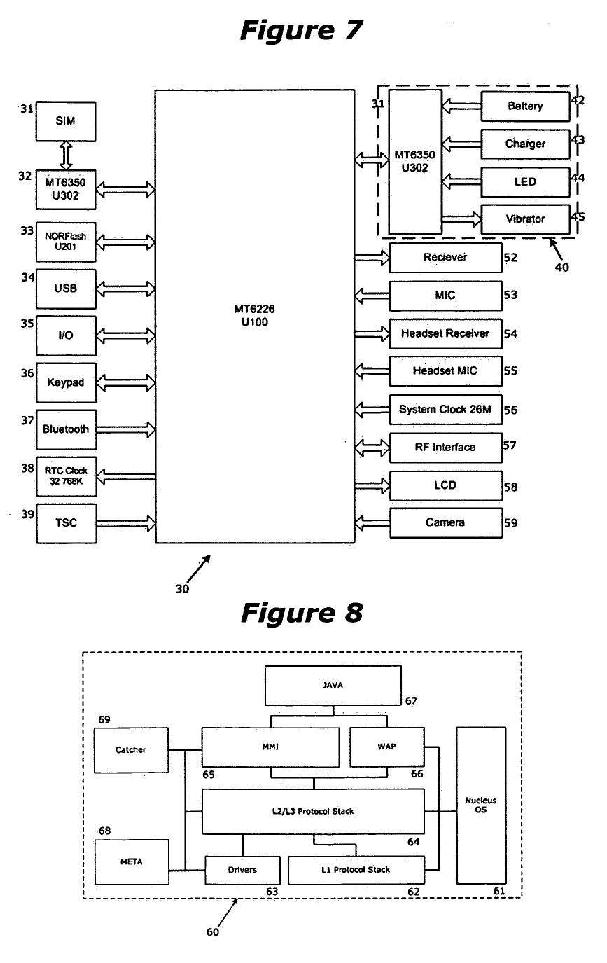

In this embodiment, the baseband module, as shown in FIG. 7, is designed to send data to and receive data from: a USB device (34), an I/O device (35), a keypad (36), a Bluetooth device (37), a Real Time Clock (RTC) (38), a Time Stamp Counter (TSC) (39), a microphone (53), a headset receiver (54), a headset microphone (55), a system clock (56), a display interface (57) and a camera (58). Other devices known to be used in typical digital watches may also be incorporated in this watch phone. These devices are included to enhance the functions of the watch phone.

A Subscriber Identity Mobile (SIM) Card, if there is one needed, may be inserted into the watch through the SIM card interface (72). The baseband module also connects to a controller (31) for interfacing with the SIM card (32). The SIM card stores the information for connecting to the GSM or 3G telephone networks. It is also able to store other information of the user such as telephone numbers or text messages depending on the size of the memory of the SIM card.

The baseband module also controls the memory for storing data in the watch. The memory in this preferred embodiment may be a NorFlash memory (33). The memory is used for storing firmware and drivers for the watch.

The baseband module is also responsible for collecting status information from a power supply system (40). The power supply system may have a rechargeable battery (42), which may connect to a charger (43), a LED (44) for indicating the power status and preferably a vibrator (41). The power supply system is controlled by a controller (41). It determines and indicates the power on/off status, the charging status and the power level. It also controls the vibrating function of the watch. In the embodiment the controller (31) for the SIM card and the controller (41) for the power supply system are integrated in one single chip.

Referring to FIGS. 9 and 10, the watch may also have a number of interfaces for connecting external devices. Those interfaces include USB interface (72), a power supply socket (76), a microphone socket (75) and a headphone socket (75).

The wrist watch phone includes a display (16) for interfacing with the user. The display is typically a 16 bit OLED display having enough capacity to display around 65K of different colours. The display may be in the form of Thin Film Transistor Liquid Crystal Display (TFTLCD), touch screen or LCD made of glass or plastic.

The display is the main visual output of the wrist watch mobile phone. It provides various graphic user interfaces (GUI) to show the time as well as the mobile phone interface, including, for example, a dialing keypad display, an address book, an email client, etc. The display is preferably in the form of a touch screen, such that it can be used to accept input from the user. The display is used to show all of the functions typically used with a mobile telephone, and wrist watch. Preferably, these functions are accessible by the users through the GUI presented on the display of the watch phone. Typically only a subset of these functions appears on the display at any one time. A user may navigate through the GUI such as menu or icons to switch to different functions.

The housing (10) of the watch, also known as the watch “shell”, encloses all the electronic components of the communication module and the time piece. As mentioned above, the size of the housing is generally smaller than that of a typical mobile phone such that it is suitable to be worn on the wrist. There may be one or more buttons located on the housing, preferably at the front or side of the housing for a user to activate certain functions of the watch.

The wrist watch phone may have watch straps (11) for fastening the watch around the wrist. The watch straps can be made of different variety of materials, such as, leather, metal, sponge, plastic or other materials, or mixtures of those known to be used with watch bands. The strap may be expendable to fit over the hand or else, it may have a fastening capable of opening and closing for wearing.

The wrist watch phone may also include an internal antenna. (15) as shown in FIGS. 2 to 5. Typical antennas for GSM telephone networks are relatively large and cumbersome compared to the size of a wrist watch. In one preferred embodiment, the size of the internal antenna (15) is reduced to fit inside the housing of the watch. The internal antenna (15) of one preferred embodiment is embedded entirely inside the housing and it supports the transmission and reception of the GSM frequency bands mentioned above.

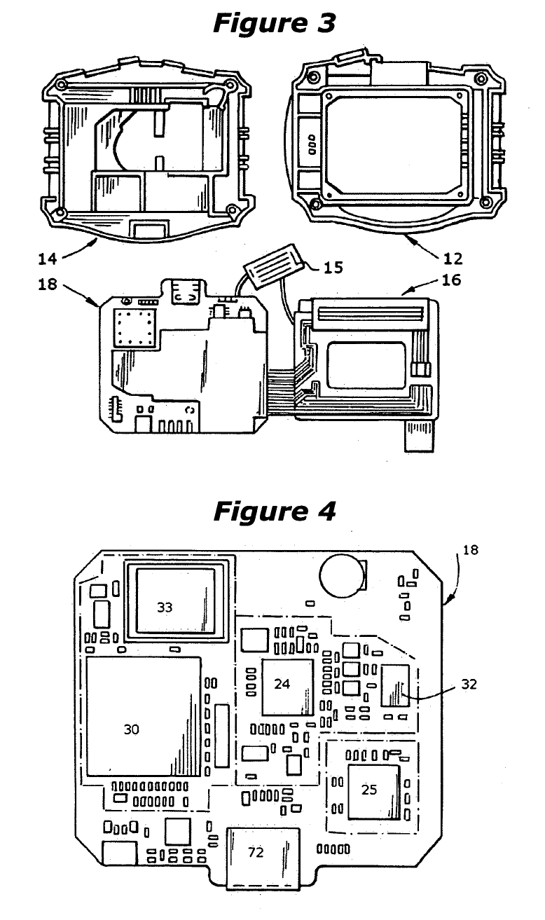

Referring to FIGS. 2 to 3, the internal antenna (15) is substantially in sheet form. In one preferred embodiment, the antenna (15) is substantially flat with a bent near one or more of the edges of the planar body. Preferably, the sheet form internal antenna is made of copper and plastic. This sheet form antenna will operate optimally with a housing (10) made of titanium and non-metal materials such as stainless steel, plastics, polycarbonate plastics, resin, glass or ceramic.

As another preferred embodiment, the antenna may extend along part or all of the watch band. A combination of having some of the antenna located within the housing, and the remainder situated within or along the watchband, may also be utilised. Also, it may be permitted, according to the invention, to provide an antenna as a separate and removable component. This may ideally operate when the user needs to receive a weak signal, and the separate antenna may then be attached to the watch phone, either to enhance the attached antenna or to replace it.

A rechargeable battery may be installed inside the wrist watch phone to provide power to the watch. The battery module may provide power to support the communication module with 200 minutes talk time, or 80 hours standby time, for instance. In one preferred embodiment, the entire battery module is embedded inside the housing. The housing normally has a small opening for used in order to recharge the battery.

The communication module may provide a Voice over IP (VoIP) facility. In other words, the wrist watch phone of a preferred embodiment supports communication using IP packets. The wrist watch mobile may directly connect to an IP number for communication, in this situation.

The wrist watch phone may have any one of the functions of an advanced mobile phone. It may provide the functions of sending and receiving digital data, emails, telephone calls, text messages, multimedia messages, files, videos, sounds, voices, music, pictures and games. The wrist watch phone may provide other wireless connection for other wireless electronic devices, and such wireless connection may be an infra-red connection, Bluetooth connection, etc. New or improved such functions may be installed into the wrist watch phone by downloading new programs and upgrades through the communication module, if desired.

In another embodiment, the wrist watch phone may include a Global Positioning System (GPS) module. The GPS may be used to determine the location of the wearer and this may also be used for tracking the location of the wearer. For example, a child may wear this watch with the GPS function enabled. If the child wanders outside school or home, the watch may be able to detect that and then send an email or SMS to the parent to notify them of the child's whereabouts. The parent may then telephone the child via the wrist watch mobile phone.

When the wrist watch phone is used for tracking a person, it may be desirable to lock the watch around a person's wrist such a way that it is not easy to remove the watch. One way to lock the watch to a person is provide a security encryption device for securely locking the wrist watch around a wrist. The security encryption device may only then be unlocked by sending a digital key to the watch via the communication device. In this way, it is possible to unlock or re-lock the watch remotely. A remote signalling device may be used for sending out the key to lock or unlock the security encryption device through the GSM network.

Referring to FIG. 8, which shows the software architecture (60) of the watch, the wrist watch phone may has a software operating system to interface with the hardware. The operating system has a Nucleus OS (61) for supporting the basic functions of an embedded system, these functions include file I/O, bus I/O, etc.

In addition to the Nucleus OS, there may be a number of protocol stack layers (62 and 64) for handing digital signals processing of the mobile communications. Each of the stack layers may have one or more processing functions to control or map the data between logical and physical channels. There are also a number of device drivers (63), each of which is designed to provide control for one or more hardware components. There may be device drivers for the SIM module, Real Time Clock (RTC), Keypad, etc. With the device drivers, it is possible to create a program to control the devices connecting to the baseband module.

The protocol stack layers and device drivers only provide basic programming interfaces controlling a hardware component and these basic programming interfaces provide very limited functions. Typically, so as to make the software programming more user friendly, there may be a Man to Machine Interface (MMI) layer (65) centralising all the functions provide by the protocol stack layers and device drivers. Then MMI provides a set of Application Programming Interfaces (API) that are compatible to a high level computer languages such as JAVA (67), WAP (68), etc, such that developers may able to create new applications or update existing applications for the wrist watch mobile phone. The watch may then download new applications and updates and run them. As a result, the functions of the watch may be enriched as more applications become available. The manufacturer may also provide updates to the firmware to the watch. With the API provided, the wrist watch phone may optimise its performance with new application updates.

In another embodiment, the battery usage is minimised by reducing the display of unnecessary graphics.

In the drawings, the list of parts is shown in the following table, for one preferred embodiment of the wrist watch phone.

TABLE 2
Parts Included in a GSM Watch Phone.

| number | name | Figure |
|---|---|---|
| 10 | watch | 1 |
| 11 | straps | 1 |
| 12 | watch shell front | 3 |
| 14 | watch shell back | 3 |
| 16 | display | 3 |
| 18 | communication module | 3 |
| 20 | R/F module | 7 |
| 22 | T/R ASM | 7 |
| 23 | SAW filter | 7 |
| 24 | Transceiver | 7 |
| 25 | PA | 7 |
| 30 | baseband | 7 |
| 31 | controller | 8 |
| 32 | SIM | 8 |
| 33 | NorFlash | 8 |
| 34 | USB | 8 |
| 35 | I/O | 8 |
| 36 | Keypad | 8 |
| 37 | Bluetooth | 8 |
| 38 | RTC | 8 |
| 39 | TSC | 8 |
| 40 | power supply | 8 |
| 41 | controller | 8 |
| 42 | battery | 8 |
| 43 | charger | 8 |
| 44 | LED | 8 |
| 45 | vibrator | 8 |
| 52 | Receiver | 8 |
| 53 | MIC | 8 |
| 54 | Headset Receiver | 8 |
| 55 | Headset MIC | 8 |
| 56 | System Clock | 8 |
| 57 | RF Interface | 8 |
| 58 | LCD | 8 |
| 59 | Camera | 8 |
| 60 | software architecture | 9 |
| 61 | Nucleus OS | 9 |
| 62 | L1 Protocol Stack | 9 |
| 63 | Drivers | 9 |
| 64 | L2/L3 Protocol Stack | 9 |
| 65 | MMI | 9 |
| 66 | WAP | 9 |
| 67 | JAVA | 9 |
| 68 | META | 9 |
| 69 | Catcher | 9 |
| 72 | USB | 10 |
| 73 | SIM Interface | 11 |
| 74 | Mic Connector | 11 |
| 75 | Audio Jack | 11 |
| 76 | charger interface | 11 |

### INDUSTRIAL APPLICATION

As described above, the present invention is applicable to a mobile watch phone wearable on a wrist. According to the present invention, the mobile watch phone is adapted to connect to a variety of GSM telephone networks for communication of voice, video and data. The mobile watch phone also provides a variety of functions to facility mobile phone communication such as SMS, address book and email.

The mobile watch phone described above may also have a GPS device for tracking the location of the mobile watch phone. It can be used for tracking the location of the user wearing it.

1. A wrist watch phone wearable by a person comprising
a communication module adapted to operate under Global System of Mobile (GSM) telephone networks, to operate with a plurality of GSM frequency bands, and to send audio data across said GSM telephone networks;
an internal antenna being substantially in sheet form and connecting to said communication module, wherein said internal antenna is adapted to transmit signals to and receive signals from said GSM telephone networks;
a display adapted to at least display time, and to provide a graphic interface for showing a status of said communication module;
a power supply connecting to said communication module, wherein said power supply is adapted to provide power to said wrist watch mobile phone; and
a housing means adapted to enclose said display, said internal antenna, said communication module and said power supply;
wherein the housing means comprises any one or more of titanium, and non-metal.

2. A wrist watch phone as claimed in claim 1, wherein said non-metal comprises any one or more of stainless steel, plastics polycarbonate plastic, resin, glass and ceramic.

3. A wrist watch phone as claimed in claim 1, comprising a retaining means adapted to secure said retaining means around a wrist.

4. A wrist watch phone as claimed in claim 1, wherein said communication module adapted to operate with at least three GSM frequency bands.

5. A wrist watch phone as claimed in claim 1, wherein said communication module adapted to operate in quad bands mode.

6. A wrist watch phone as claimed in claim 1, wherein said GSM frequency bands include any one or more of 800 Mhz, 850 MHz, 900 MHz, 1800 MHz, 1900 MHz, 2000 MHz, 2100 Mhz, 2500 MHz, 2600 MHz, 2700 MHz, 2800 MHz, 2900 MHz, 3000 MHz, 3500 MHz, 4000 MHz, 4500 MHz, and 5000 MHz.

7. A wrist watch phone as claimed in claim 1, wherein said communication module adapted to operate under Voice Over IP (VoIP), Wi-Fi, InfraRed, Worldwide interoperability Microwave Access (WiMAX).

8. A wrist watch phone as claimed in claim 1, wherein said internal antenna comprises of plastic and copper to produce a maximum spurious emission limit of −13 DBM.

9. A wrist watch phone as claimed in claim 1, wherein said power supply includes a non-rechargeable or solar power battery or panel.

10. A wrist watch phone as claimed in claim 1, wherein said power supply includes a rechargeable battery adapted to provide power to said communication module and said display module.

11. A wrist watch phone as claimed in claim 10, wherein said rechargeable system comprises a USB connector.

12. A wrist watch phone as claimed in claim 10, wherein said rechargeable system is power supplied by limited power source and mounted on PCB of flammability class V-0 or above.

13. A wrist watch phone as claimed in claim 10, wherein said rechargeable system operates with a rate input range between 110 to 240V, 50 to 60 Hz, a rate output range between 0.000001 mA to 4500 mA, and an operation temperature between 1 to 78° C.

14. A wrist watch phone as claimed in claim 1, wherein said display is any one of organic light emitting system applied onto an organic substrate.

15. A wrist watch phone as claimed in claim 1, wherein said display is any one of Thin Film Transistor Liquid Crystal Display (TFTLCD) or Liquid Crystal Display (LCD).

16. A wrist watch phone as claimed in claim 1, wherein said display is comprises a system using amorphous or polycrystalline silicon, or indium tin oxide.

17. A wrist watch phone as claimed in claim 1, wherein said display is made of any one of plastic or glass.

18. A wrist watch phone as claimed in claim 1, wherein said display is a touch screen.

19. A wrist watch phone as claimed in claim 1, wherein said display is adapted to display 256 colours.

20. A wrist watch phone as claimed in claim 1, wherein said communication module is adapted to communicate via IP Packets Exchange network.

21. A wrist watch phone as claimed in claim 1, wherein said wrist watch is adapted to operate with a Subscriber Identity Module (SIM) card.

22. A wrist watch phone as claimed in claim 1, wherein said wrist watch includes a Global Positioning System (GPS) module connecting to said communication module, wherein said GPS module determines at least one coordinate data of said wrist watch phone and displays said coordinate data on said display.

23. A wrist watch phone as claimed in claim 1, wherein said communication module has a baseband module adapted to process, send and receive digital data.

24. A wrist watch phone as claimed in claim 1, wherein said digital data include emails, telephone calls, text messages, multimedia messages, files, videos, sounds, voices, music, pictures and games.

25. A wrist watch phone as claimed in claim 23, wherein said wrist watch is adapted to send an email when said GPS has detected that said wrist watch phone is outside a predetermined geographical area.

26. A wrist watch phone as claimed in claim 1, wherein said wrist watch has a Bluetooth communication module to connect to a Bluetooth compatible device.

27. A wrist watch phone as claimed in claim 1, wherein said retaining means includes a security encryption device for securely locking said wrist watch around a wrist.

28. A wrist watch phone as claimed in claim 27, wherein said security encryption device is adapted to receive wireless signals for locking and unlocking said security encryption device.

29. A wrist watch phone as claimed in claim 1, wherein said communication module includes a customized Printed Circuit Board (PCB).

30. A wrist watch phone as claimed in claim 29, wherein said PCB includes
a Radio Frequency (RF) module adapted to send and receive digital signals through GSM telephone networks using one of said three multiply frequency bands, and
a baseband module adapted to convert data from at least one input to said digital signals and to convert said digital signals from said RF module to data for output devices.

31. A wrist watch phone as claimed in claim 30, wherein said baseband module is adapted to send and receive data from at least one of the devices including: a USB device, an I/O device, a keypad, a Bluetooth device, a Real Time Clock (RTC), a Time Stamp Counter (TSC), a Microphone, a headset, a system clock, a display and a camera.

32. A wrist watch phone as claimed in claim 30, wherein said baseband module is adapted to collect status information from said rechargeable battery module and display said status information on said display.

33. A software module for use in the wrist watch phone as claimed in claim 1, said software comprising:
a protocol stack adapted to provide application programming interface (API) for said communication module; and
a man to machine interface adapted to accept input from a user and pass said input to said communication module using said API, and to display output from said communication module using said API.

34. A software module as claimed in claim 33, wherein said API in a format compatible with at least one high level computer languages.

35. A software module as claimed in claim 34, wherein said API in a format compatible with wireless application protocol.

36. A software module as claimed in claim 33, wherein said protocol stack has a battery control module for minimizing battery usage by optimizing the use of graphics

37. A software module as claimed in claim 33, wherein said protocol stack is adapted to handle IP Exchange packets.
